(19) United States
(12) Patent Application Publication
(10) Pub. No.: US 2025/0329494 A1
(43) Pub. Date: Oct. 23, 2025

(54) MULTILAYER CERAMIC CAPACITOR

(71) Applicant: Murata Manufacturing Co., Ltd., Nagaokakyo-shi (JP)

(72) Inventors: Akira ISHIZUKA, Nagaokakyo-shi (JP); Akira TANAKA, Nagaokakyo-shi (JP)

(21) Appl. No.: 19/251,873

(22) Filed: Jun. 27, 2025

Related U.S. Application Data
(63) Continuation of application No. PCT/JP2023/041747, filed on Nov. 21, 2023.

(30) Foreign Application Priority Data
Dec. 28, 2022 (JP) 2022-212596

(51) Int. Cl. H01G 4/005; H01G 4/232; H01G 4/30

(52) U.S. Cl. CPC H01G 4/005; H01G 4/232; H01G 4/30

(57) ABSTRACT

A multilayer ceramic capacitor includes an internal layer portion including dielectric layers and internal electrode layers. Internal electrode layers include counter portions overlapping each other in a layering direction, and extension portions extending to an end surface or a side surface of the multilayer body, and not overlapping each other in the layering direction. The internal electrode layers include communicating holes communicating in the layering direction and into which a dielectric of a dielectric layer enters. An existence ratio of the communicating holes into which the dielectric enters is higher in a connecting region of the counter portions to which the extension portions are connected than in a center of the counter portions, and is higher in the connection region than in the center of the extension portions.

### CROSS REFERENCE TO RELATED APPLICATIONS

This application claims the benefit of priority to Japanese Patent Application No. 2022-212596 filed on Dec. 28, 2022 and is a Continuation Application of PCT Application No. PCT/JP2023/041747 filed on Nov. 21, 2023. The entire contents of each application are hereby incorporated herein by reference.

### BACKGROUND OF THE INVENTION

### 1. Field of the Invention

The present invention relates to multilayer ceramic capacitors.

### 2. Description of the Related Art

In general, multilayer ceramic capacitors each include a base body in which internal electrode layers and dielectric layers are alternately laminated, and an external electrode provided on an outer surface of the base body, and the dielectric layers are made of a ceramic dielectric material (for example, refer to Japanese Unexamined Patent Application, Publication No. 2016-127262).

In order to increase the capacitance of the multilayer ceramic capacitor, it is necessary to increase the opposing surface area between the adjacent internal electrode layers in the base body.

For this purpose, it is effective to increase the density of the electrically conductive material of the internal electrode layers, that is, the density of the internal electrode layers. With such a configuration, it is possible to increase the continuity of the internal electrode layers and increase the opposing surface area between the adjacent internal electrode layers.

However, when the continuity of the internal electrode layers becomes high, the difference in shrinkage rate between the internal electrode layers and the dielectric layers becomes large, such that delamination occurs at the boundary portion between the internal electrode layers and the dielectric layers.

In particular, delamination is likely when subjected to a thermal history due to repetition, leading to structural defects in the base body, and thus insulation failure is likely to occur at the time of voltage application, which causes failure.

Therefore, there is a need to develop multilayer ceramic capacitors each having a large capacitance and reducing or preventing delamination.

### SUMMARY OF THE INVENTION

Example embodiments of the present invention provide multilayer ceramic capacitors, each including a large capacitance and each able to reduce or prevent delamination occurring at a boundary portion between internal electrode layers and dielectric layers.

The inventors of example embodiments of the present invention have discovered that delamination occurring at the boundary portion between the internal electrode layers and the dielectric layers can be reduced or prevented by adjusting the distribution of the communication holes into which the dielectric has entered in the internal electrode layers.

An example embodiment of the present invention provides a multilayer ceramic capacitor which includes a multilayer body including an inner layer portion including a plurality of dielectric layers and a plurality of internal electrode layers alternately laminated, two main surfaces opposed to each other in a lamination direction, two end surfaces opposed to each other in a length direction intersecting the lamination direction, and two lateral surfaces opposed to each other in a width direction intersecting the lamination direction and the length direction, and an external electrode connected to the plurality of internal electrode layers on at least one of the two lateral surfaces or the two end surfaces of the multilayer body, in which the plurality of internal electrode layers include first internal electrode layers and second internal electrode layers, the first internal electrode layers and the second internal electrode layers each include a counter portion overlapping therewith in a plan view in the lamination direction, and an extension portion extending from the counter portion toward one of the two end surfaces or one of the lateral surfaces of the multilayer body and does not overlap therewith in a plan view in the lamination direction, the plurality of internal electrode layers each include a communication hole communicating in the lamination direction and into which a dielectric of the plurality of dielectric layers has entered, and an existence ratio of the communication hole into which the dielectric has entered is higher at a connection region of the counter portion to which the extension portion is connected than at a central portion of the counter portion and higher than a central portion of the extension portion.

According to example embodiments of the present invention, it is possible to reduce or prevent delamination occurring at the boundary portion between the internal electrode layers and the dielectric layers, while maintaining a large capacitance.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic perspective view of a multilayer ceramic capacitor 1 according to a first example embodiment of the present invention.

FIG. 2 is a cross-sectional view taken along the line II-II in FIG. 1, and shows a half above a middle portion of the multilayer ceramic capacitor 1 according to the first example embodiment of the present invention in the lamination direction T (first example embodiment).

FIG. 3 is a cross-sectional view taken along the line III-III in FIG. 1, and shows a half above the middle portion of the multilayer ceramic capacitor laccording to the first example embodiment of the present invention in the lamination direction T.

FIG. 4 is a cross-sectional view of the multilayer ceramic capacitor 1 according to the first example embodiment of the present invention taken along a first internal electrode layer 15A.

FIG. 5 is a cross-sectional view of the multilayer ceramic capacitor laccording to the first example embodiment of the present invention taken along a second internal electrode layer 15B.

FIG. 6 is a flowchart showing an example of a method of manufacturing the multilayer ceramic capacitor laccording to the first example embodiment of the present invention.

FIG. 7 is a process chart showing an example of a method of manufacturing the multilayer ceramic capacitor laccording to the first example embodiment of the present invention.

FIG. 8 is a process chart showing an example of a method of manufacturing the multilayer ceramic capacitor laccording to the first example embodiment of the present invention.

FIG. 9 is a process chart showing an example of a method of manufacturing the multilayer ceramic capacitor 1 according to the first example embodiment of the present invention.

FIG. 10 is a process chart showing an example of a method of manufacturing the multilayer ceramic capacitor 1 according to the first example embodiment of the present invention.

FIG. 11 is a process chart showing an example of a method of manufacturing the multilayer ceramic capacitor 1 according to the first example embodiment of the present invention.

FIG. 12 is a process chart showing an example of a method of manufacturing the multilayer ceramic capacitor 1 according to the first example embodiment of the present invention.

FIG. 13 is a process chart showing a method of manufacturing the multilayer ceramic capacitor 1 according to a second example embodiment of the present invention.

FIG. 14 is a process chart showing a method of manufacturing the multilayer ceramic capacitor 1 according to the second example embodiment of the present invention.

FIG. 15 is a process chart showing an example of a method of manufacturing the multilayer ceramic capacitor 1 according to the second example embodiment of the present invention.

FIG. 16 is a process chart showing an example of a method of manufacturing the multilayer ceramic capacitor 1 according to the second example embodiment of the present invention.

### DETAILED DESCRIPTION OF THE EXAMPLE EMBODIMENTS

Example embodiments of the present invention will be described in detail below with reference to the drawings.

### First Example Embodiment

Hereinafter, a multilayer ceramic capacitor 1 of a first example embodiment of the present invention will be described.

The multilayer ceramic capacitor 1 is a three-terminal multilayer ceramic capacitor in which lateral surface external electrodes 4 are each provided on a corresponding one of two lateral surfaces B opposed to each other and end surface external electrodes 3 are each provided on a corresponding one of two end surfaces C opposed to each other. However, the position where the external electrodes are provided can be changed by changing the shape of internal electrode layers 15, particularly, the shapes of lateral surface extension portions 15Ab and end surface extension portions 15Bb described later. For this reason, an example embodiment of the present invention is applicable to three-terminal multilayer ceramic capacitors, two-terminal ceramic capacitors, and multilayer ceramic capacitors having other shapes, for example.

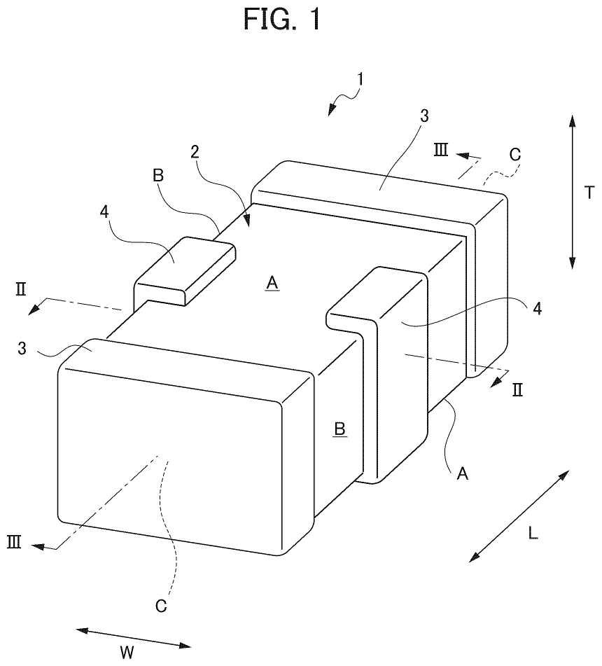

FIG. 1 is a schematic perspective view of a multilayer ceramic capacitor 1 according to the first example embodiment.

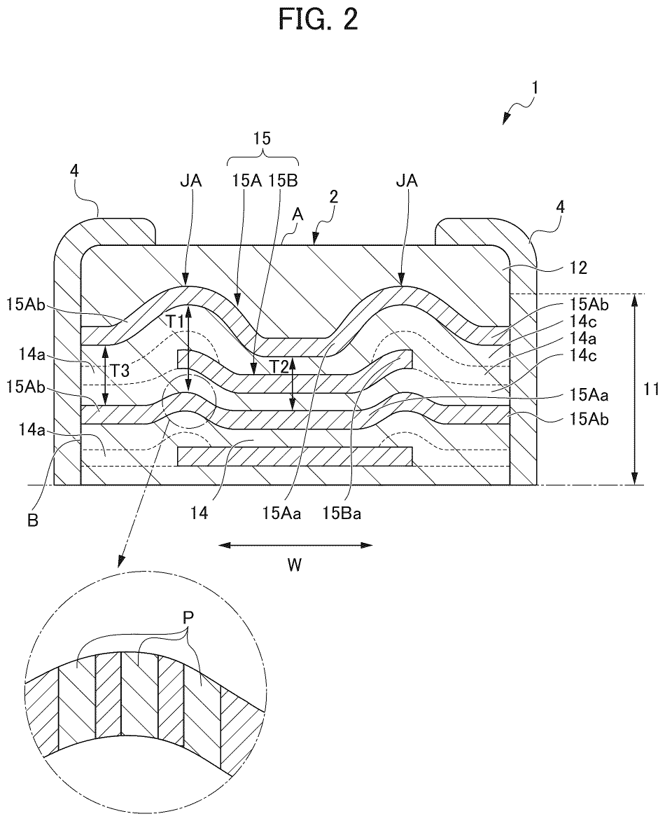

FIG. 2 is a cross-sectional view (WT cross-sectional view) of the multilayer ceramic capacitor 1 taken along the line II-II in FIG. 1, and shows a half above the middle portion of the multilayer ceramic capacitor 1 in the lamination direction T.

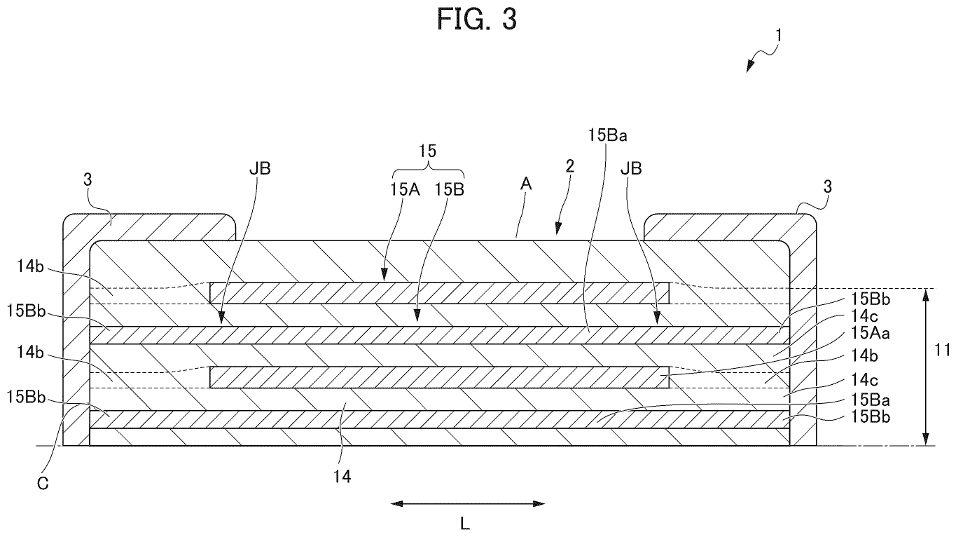

FIG. 3 is a cross-sectional view (LT cross-sectional view) of the multilayer ceramic capacitor 1 taken along the line III-III in FIG. 1, and shows a half above the middle portion of the multilayer ceramic capacitor 1 in the lamination direction T.

### Multilayer Ceramic Capacitor 1

The multilayer ceramic capacitor 1 includes end surface external electrodes 3 provided on both end surfaces C of the multilayer body 2 in the length direction L, and lateral surface external electrodes 4 provided on both lateral surfaces B of the multilayer body 2 in the width direction W.

The multilayer body 2 includes an inner layer portion 11 including a plurality of sets of dielectric layers 14 and internal electrode layers 15, and an outer layer portion 12.

The dimensions of the multilayer ceramic capacitor 1 are not particularly limited, but may be, for example, about 0.6 mm or more and about 3.2 mm or less in the length direction L, about 0.3 mm or more and about 2.5 mm or less in the lamination direction T, and about 0.3 mm or more and about 2.5 mm or less in the width direction W.

In the present specification, as a term expressing the orientation of the multilayer ceramic capacitor 1, a direction in which the dielectric layers 14 and the internal electrode layers 15 are laminated in the multilayer ceramic capacitor 1 is defined as a lamination direction T.

A direction intersecting the lamination direction T and in which the pair of end surface external electrodes 3 are provided is defined as a length direction L.

A direction intersecting both the length direction L and the lamination direction T is defined as a width direction W.

In the present example embodiment, the lamination direction T, the length direction L, and the width direction W are orthogonal or substantially orthogonal to each other.

### Multilayer Body 2

The multilayer body 2 includes an inner layer portion 11 and outer layer portions 12 provided on both sides of the inner layer portion 11 in the lamination direction T.

The multilayer body 2 preferably includes rounded corner portions and rounded ridge portions.

The corner portions each refer to a portion where the three surfaces of the multilayer body intersect with one another, and the ridge line portions each refer to a portion where the two surfaces of the multilayer body intersect with each other.

The dimensions of the multilayer body 2 are not particularly limited, but may be, for example, about 0.6 mm or more and about 3.2 mm or less in the length direction L, about 0.3 mm or more and about 2.5 mm or less in the lamination direction T, and about 0.3 mm or more and about 2.5 mm or less in the width direction W.

### Inner Layer Portion 11

In the inner layer portion 11, a plurality of dielectric layers 14 and a plurality of internal electrode layers 15 are laminated along the lamination direction T.

### Dielectric Layer 14

The dielectric layers 14 are each made of a ceramic material.

As the ceramic material, for example, a dielectric ceramic including BaTiO₃ as a main component is used.

Further, as the ceramic material, a material obtained by adding at least one subcomponent such as, for example, a Mn compound, a Fe compound, a Cr compound, a Co compound, or a Ni compound to these main components may be used.

The dielectric layers 14 include dielectric layers 14c manufactured from a ceramic green sheet described later, and dielectric layers 14a and 14b manufactured from a ceramic paste applied on the ceramic green sheet.

### Internal Electrode Layer 15

The internal electrode layers 15 are each preferably made of a metal material such as, for example, Ni, Cu, Ag, Pd, an Ag—Pd alloy, Au, or other materials.

The thickness of each of the internal electrode layers 15 is not particularly limited, but is, for example, preferably about 0.25 μm or more and about 0.6 μm or less, and more preferably about 0.3 μm or more and about 0.5 μm or less.

For example, fourteen or more and 1000 or less internal electrode layers 15 can be embedded in the inner layer portion 11.

The internal electrode layers 15 include first internal electrode layers 15A and second internal electrode layers 15B that are alternately provided. The first internal electrode layers 15A and second internal electrode layers 15B include counter portions which overlap each other in a plan view in the lamination direction T, and extension portions which extend from the counter portions toward the end surfaces C or the lateral surfaces B of the multilayer body 2 and do not overlap each other in a plan view in the lamination direction T.

With the first internal electrode layers 15A and the second internal electrode layers 15B, a capacitance is generated at the counter portions which overlap each other in a plan view in the lamination direction T via the dielectric layer 14.

In addition, the extension portion extending from each of the counter portions extends toward and is exposed at the end surface C or the lateral surface B of the multilayer body 2 in order to connect the counter portion with a corresponding one of the external electrodes.

Since the shape of each of the extension portions corresponds to the position and shape of each of the external electrodes provided according to the configuration of mounting on the wiring board, various modifications are possible.

FIGS. 1 to 3 each show the multilayer ceramic capacitor 1 in which two lateral surface extension portions 15Ab of the first internal electrode layers 15A respectively extend toward the opposite lateral surfaces B of the multilayer body 2, and two end surface extension portions 15Bb of the second internal electrode layer 15B respectively extend toward the opposite end surfaces C of the multilayer body 2.

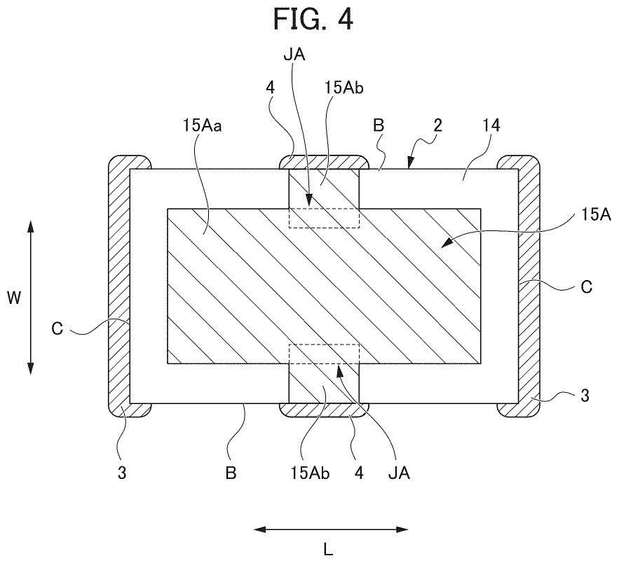

FIG. 4 is a cross-sectional view of the multilayer ceramic capacitor 1 taken along one of the first internal electrode layers 15A.

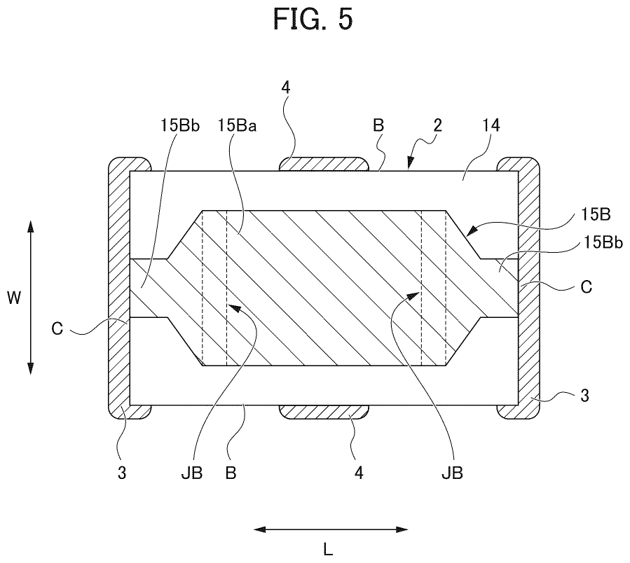

FIG. 5 is a cross-sectional view of the multilayer ceramic capacitor 1 taken along one of the second internal electrode layers 15B.

### First Internal Electrode Layer 15A

As shown in FIG. 4, each of the first internal electrode layers 15A includes a rectangular or substantially rectangular first counter portion 15Aa which is slightly smaller than the multilayer body 2 and whose sides are spaced apart from the end surface C and the lateral surface B by a certain distance, and lateral surface extension portions 15Ab extending from the first counter portion 15Aa toward the lateral surfaces B on both sides.

The first counter portion 15Aa includes connection regions JA which are portions respectively connected to a corresponding one of the lateral surface extension portion 15Ab.

FIG. 2 and FIG. 4 each show the connection regions JA to which the lateral surface extension portions 15Ab of the first counter portion 15Aa are respectively connected.

In the present example embodiment, the first counter portion 15Aa includes two connection regions JA corresponding to the two lateral surface extension portions 15Ab.

The lateral surface extension portions 15Ab extending toward the two opposite lateral surfaces B are each exposed at the lateral surface B of the multilayer body 2, and are each connected to the lateral surface external electrodes 4 provided on both lateral surfaces B in the width direction W of the multilayer body 2.

In each of the first internal electrode layers 15A, the dimension of the lateral surface extension portion 15Ab in the length direction L is shorter than the dimension of the first counter portion 15Aa in the length direction L.

In this manner, by reducing the dimension in the length direction L of the lateral surface extension portion 15Ab, it is possible to reduce or prevent intrusion of moisture from the outside, and thus it is possible to improve the reliability of the multilayer ceramic capacitor.

FIG. 4 shows a configuration in which both of the two lateral surface extension portions 15Ab are shorter than the first counter portion 15Aa in the length direction L.

### Second Internal Electrode Layer 15B

As shown in FIG. 5, each of the second internal electrode layers 15B as a whole extends between both end surfaces C of the multilayer body 2 in the length direction L, and are spaced apart from both lateral surfaces B in the width direction W by a certain distance.

In each of the second internal electrode layers 15B, a central portion of the octagonal shape separated from both of the end surfaces C by a certain distance corresponds to a second counter portion 15Ba, and portions each extending from the second counter portion 15Ba toward the two end surfaces C opposed to each other correspond to end surface extension portions 15Bb.

The second counter portion 15Ba includes connection regions JB which are portions respectively connected to a corresponding one of the end surface side extension portions 15Bb.

FIG. 3 and FIG. 5 each show the connection regions JB to which the end surface extension portions 15Bb of the second counter portion 15Ba are respectively connected.

In the present example embodiment, the second counter portion 15Ba includes two connection regions JB corresponding to the two end surface extension portions 15Bb.

The end surface extension portions 15Bb each extend toward a corresponding one of the two end surfaces C opposed to each other, are each exposed at the end surface C of the multilayer body 2, and are connected to the end surface external electrodes 3 provided on both lateral surfaces of the multilayer body 2 in the length direction L.

The second counter portions 15Ba and the first counter portions 15Aa are opposed to each other, such that a capacitance is generated.

Each of the end surface extension portions 15Bb includes a transition region in which the dimension in the width direction W gradually decreases, and an extension region which extends from the transition region toward the end surface C and in which the dimension in the width direction W is shorter than the dimension in the width direction of the second counter portion 15Ba.

In this way, by shortening the dimension in the width direction W of the extension portion of the end surface extension portion 15Bb, it is possible to reduce or prevent intrusion of moisture from the outside, and thus it is possible to improve the reliability of the multilayer ceramic capacitor.

FIG. 5 shows a configuration in which the extension portions of the two end surface extension portions 15Bb are both shorter than the second counter portion 15Ba in the width direction W.

### Outer Layer Portion 12

As shown in FIGS. 2 and 3, the outer layer portion 12 is a dielectric layer having a certain thickness and provided adjacent to the main surface A of the inner layer portion 11.

The outer layer portion 12 is made of the same material as the dielectric layer 14 of the inner layer portion 11.

The thickness of the dielectric layer is not particularly limited, but is, for example, preferably about 0.3 μm or more and about 1.5 μm or less, and more preferably about 0.5 μm or more and about 1 μm or less.

The multilayer body 2 including the inner layer portion 11 and the outer layer portion 12 may include, for example, 14 or more and 1000 or less dielectric layers.

### End Surface External Electrode 3

The end surface external electrodes 3 are provided on both end surfaces C of the multilayer body 2.

Each of the end surface extension portions 15Bb of the second internal electrode layers 15B is connected to the end surface external electrodes 3.

Each of the end surface external electrodes 3 covers not only the end surface C but also a portion of the main surface A and a portion of the lateral surface B adjacent to the end surface C.

### Lateral Surface External electrode 4

The lateral surface external electrodes 4 are provided on both lateral surfaces B of the multilayer body 2.

Each of the lateral surface extension portions 15Ab of the first internal electrode layers 15A is connected to the lateral surface external electrodes 4.

Each of the lateral surface external electrodes 4 covers not only a portion of the lateral surface B but also a portion of the main surface A adjacent to the lateral surface B.

Each of the end surface external electrodes 3 and each of the lateral surface external electrodes 4 may include, for example, a configuration including a base electrode layer and a plated layer provided on the base electrode layer.

The base electrode layer includes at least one layer selected from a fired layer, an electrically conductive resin layer, a direct plated layer, and other layers as described below.

### Fired layer

The fired layer is formed by, for example, applying an electrically conductive paste including glass and metal to the multilayer body and firing the paste, and may be formed by co-firing the paste with the internal electrodes, or may be formed by firing the paste after firing the internal electrodes.

The temperature of the firing treatment is, for example, preferably about 700° C. to about 900° C.

The glass component includes, for example, at least one of B, Si, Ba, Mg, Al, Li, or other components.

The metal includes, for example, at least one pf Cu, Ni, Ag, Pd, an Ag—Pd alloy, Au, pr other metals.

The thickness of the fired layer is preferably, for example, about 3 μm or more and about 70 μm or less.

The fired layer may include a plurality of layers.

### Electrically Conductive Resin Layer

The electrically conductive resin layer is provided on the surface of the fired layer or directly on the surface of the multilayer body.

The electrically conductive resin layer may include a plurality of layers.

As an example of a method of forming the electrically conductive resin layer, for example, an electrically conductive resin paste including a thermosetting resin and a metal component is applied onto the fired layer or the multilayer body, and heat treatment is performed at a temperature of about 250° C. to about 550° C. or higher to thermally cure the resin, thus forming the electrically conductive resin layer.

At this time, the atmosphere during the heat treatment is, for example, preferably an N₂ atmosphere.

Further, in order to prevent scattering of the resin and oxidation of various metal components, the oxygen concentration is, for example, preferably about 100 ppm or less.

The thickness of the electrically conductive resin layer in the central portion of the end surface C is preferably about 10 μm or more and about 150 μm or less, for example.

As the resin of the electrically conductive resin layer, for example, various known thermosetting resins such as an epoxy resin, a phenol resin, a urethane resin, a silicone resin, or a polyimide resin may be used.

Among them, an epoxy resin excellent in heat resistance, moisture resistance, adhesion, and the like is a suitable resins.

The resin included in the electrically conductive resin layer is, for example, preferably included in an amount of about 25 vol % or more and about 65 vol % or less with respect to the total volume of the electrically conductive resin.

Further, for example, the electrically conductive resin layer preferably includes a curing agent together with a thermosetting resin.

When an epoxy resin is used as the base resin, various known compounds such as, for example, phenol-based compounds, amine-based compounds, acid anhydride-based compounds, or imidazole-based compounds can be used as the curing agent of the epoxy resin.

Since the electrically conductive resin layer includes a thermosetting resin, the electrically conductive resin layer is more flexible than, for example, a plating film or an electrically conductive layer made of a fired product of an electrically conductive paste.

For this reason, even when a physical impact or an impact due to a thermal cycling is applied to the ceramic electronic component, the electrically conductive resin layer defines and functions as a buffer layer, and cracks in the ceramic electronic component can be prevented.

As the metal included in the electrically conductive resin layer, for example, Ag, Cu, or an alloy thereof can be used.

Alternatively, for example, a metal powder having a surface coated with Ag may be used.

When an Ag-coated metal powder is used, for example, Cu or Ni is preferably used as the metal powder.

Alternatively, Cu subjected to an antioxidant treatment may be used.

The reason why the electrically conductive metal powder of Ag is used as the electrically conductive metal is that Ag has the lowest specific resistance among metals and is therefore suitable for an electrode material, and Ag is a noble metal and is not oxidized and has a high counteracting property.

The reason why the Ag-coated metal is used is that the metal of the base material can be made inexpensive while maintaining the characteristics of Ag.

The metal included in the electrically conductive resin layer is, for example, preferably included in an amount of about 35 vol % or more and about 75 vol % or less with respect to the total volume of the electrically conductive resin.

The shape of the metal included in the electrically conductive resin layer is not particularly limited.

The electrically conductive filler may have a spherical shape, a flat shape, or other shapes.

The average particle diameter of the metal included in the electrically conductive resin layer is not particularly limited, but may be, for example, about 0.3 μm or more and about 10 μm or less.

The metal included in the electrically conductive resin layer is mainly responsible for the electrical conductivity of the electrically conductive resin layer.

Specifically, when the electrically conductive fillers are in contact with each other, an electrical conduction path is provided inside the electrically conductive resin layer.

### Plated Layer

A plated layer may be directly provided on each of the end surfaces of the multilayer body where the internal electrodes are exposed.

That is, the multilayer ceramic capacitor may include a configuration including a plated layer electrically connected directly to the internal electrode layers and the surface electrode layer.

In such a case, the plated layer may be directly provided after the catalyst is provided on the surface of the multilayer body as a pretreatment.

The plated layer preferably includes, for example, at least one metal of Cu, Ni, Sn, Pb, Au, Ag, Pd, Bi, or Zn, or an alloy including the metal.

For example, when the first internal electrode layers and the second internal electrode layers include Ni, the direct plated layer is, for example, preferably provided using Cu having good bonding property with Ni.

The thickness per plated layer is, for example, preferably about 2 μm or more and about 15 μm or less.

The plated layer preferably does not include glass.

The metal ratio per unit volume of the plated layer is, for example, preferably about 99% by volume or more.

When plating is performed, either electrolytic plating or electroless plating may be used, but electroless plating requires pretreatment with a catalyst or the like in order to improve the plating deposition rate, and has the disadvantage of complicating the process.

Therefore, in general, electrolytic plating is preferably used.

As the plating method, for example, barrel plating is preferably used.

If necessary, an upper plating electrode provided on the surface of the lower plating electrode may be similarly provided.

When the base electrode layer is a thin film layer, the thin film layer is formed by, for example, a thin film forming method such as a sputtering method or a vapor deposition method, and is a layer having a thickness of about 1 μm or less on which metal particles are deposited.

The plated layer provided on the base electrode layer includes, for example, at least one of Cu, Ni, Ag, Pd, an Ag—Pd alloy, Au, or the like.

The plated layer may include a plurality of layers.

A two-layer configuration of, for example, Ni plating and Sn plating is preferable.

The Ni plated layer can prevent the base electrode layer from being eroded by the solder when the ceramic electronic component is mounted, and the Sn plated layer can improve the wettability of the solder when the ceramic electronic component is mounted, which facilitates the mounting.

The thickness per one plated layer is, for example, preferably about 2 μm or more and about 15 μm or less.

### Communication Hole P

The internal electrode layers 15 each include communication holes P which each penetrate the internal electrode layer 15 to communicate in the lamination direction T and into which a portion of the dielectric of the dielectric layer 14 sandwiching the internal electrode layer 15 from the lamination direction T has entered.

Inside each of the communication holes P, columnar crystals by the dielectric are provided, such that it is possible to increase the adhesion between the internal electrode layer 15 and the dielectric layer 14.

In each of the first internal electrode layers 15A, the existence ratio of the communication holes P into which the dielectric has entered is higher at a corresponding one of the connection regions JA of the first counter portion 15Aa to which the lateral surface extension portion 15Ab is connected than the central portion of the first counter portion 15Aa and higher than the central portion of the lateral surface extension portion 15Ab.

The existence ratio of the communication holes P into which the dielectric has entered can be confirmed by, for example, polishing the end surface C of the multilayer ceramic capacitor 1 at an angle in parallel or substantially in parallel to the end surface C to expose a cross section and observing the cross section using a scanning electron microscope.

Specifically, the existence ratio of the communication holes P into which the dielectric has entered in each of the connection regions JA is measured in a cross section obtained by polishing the multilayer ceramic capacitor 1 to a position where the cross section becomes about one half of the dimension of the multilayer ceramic capacitor 1 in the length direction at an angle perpendicular to the length direction L.

Next, in the above-described cross section, the inner layer portion is divided into three regions so that the thickness dimension of the inner layer portion is divided into three equal or substantially equal portions.

Thereafter, in each region, the field of view is specified so as to have a magnification at which 15 layers of the first internal electrode layers 15A are included, while centering on one end portion of the counter portion of each of the first internal electrode layers 15A.

SEM images are analyzed in the respective specified fields of view of the respective regions, and based on the area of the first internal electrode layer 15A, the area of the communication hole, and the area of the communication hole P into which the dielectric has entered which are actually present in the analysis target range, the existence ratio of the communication hole P into which the dielectric has entered is calculated by the following expression (1).

The existence ratio (%) of the communication hole P into which the dielectric has entered=(Area of communication hole P in which dielectric has entered/area of internal electrode layer+area of communication hole)×100 (1)

Finally, an average of 15 layers measured in each of the three regions is calculated as the existence ratio of the communication hole P into which the dielectric has entered in each of the connection regions JA.

Further, the existence ratio of the communication hole P into which the dielectric has entered in the central portion of the first counter portion 15Aa is measured in a cross section obtained by polishing the multilayer ceramic capacitor 1 to a position where the dimension in the length direction of the multilayer ceramic capacitor 1 becomes about one half of the dimension in the length direction of the multilayer ceramic capacitor 1 at an angle perpendicular to the length direction L.

Next, in the above-described cross section, the inner layer portion is divided into three regions so that the thickness dimension of the inner layer portion is divided into three equal or substantially equal portions.

Thereafter, in each region, the field of view is specified so as to have a magnification at which 15 layers of the first internal electrode layers 15A are included, while centering on the central portion of the first counter portion 15Aa of the first internal electrode layer 15A.

SEM images are analyzed in the respective specified fields of view of the respective regions, and based on the area of the first internal electrode layer 15A, the area of the communication hole, and the area of the communication hole P into which the dielectric has entered which are actually present in the analysis target range, the existence ratio of the communication hole P into which the dielectric has entered is calculated by the following expression (1).

The existence ratio (%) of the communication hole P into which the dielectric has entered=(Area of communication hole P in which dielectric has entered/area of internal electrode layer+area of communication hole)×100 (1)

Finally, an average of 15 layers measured in each of the three regions is calculated as the existence ratio of the communication hole P into which the dielectric has entered in the central portion of the first counter portion 15Aa.

Further, the existence ratio of the communication hole P into which the dielectric has entered in the central portion of the lateral surface extension portion 15Ab is measured in a cross section obtained by polishing the multilayer ceramic capacitor 1 to a position where the dimension in the length direction of the multilayer ceramic capacitor 1 becomes about one half of the dimension in the length direction of the multilayer ceramic capacitor 1 at an angle perpendicular to the length direction L.

Next, in the above-described cross section, the inner layer portion is divided into three regions so that the thickness dimension of the inner layer portion is divided into three equal or substantially equal portions.

Thereafter, in each region, the field of view is specified so as to have a magnification at which 15 layers of the first internal electrode layers 15A are included, while centering on the central portion of one of the lateral surface extension portions 15Ab of the first internal electrode layers 15A.

SEM images are analyzed in the respective specified fields of view of the respective regions, and based on the area of the first internal electrode layer 15A, the area of the communication hole, and the area of the communication hole P into which the dielectric has entered which are actually present in the analysis target range, the existence ratio of the communication hole P into which the dielectric has entered is calculated by the following expression (1).

The existence ratio (%) of the communication hole P into which the dielectric has entered=(Area of communication hole P in which dielectric has entered/area of internal electrode layer+area of communication hole)×100 (1)

Finally, an average of 15 layers measured in each of the three regions is calculated as the existence ratio of the communication hole P into which the dielectric has entered in the lateral surface extension portions 15Ab.

In addition, it is preferable that the existence ratio of the communication holes P into which the dielectric has entered in each of the connection regions JA is, for example, about 20% or more and about 60% or less, the existence ratio of the communication holes P into which the dielectric has entered in the central portion of the first counter portion 15Aa is, for example, about 2% or more and about 25% or less, and the existence ratio of the communication holes P into which the dielectric has entered in the central portion of the lateral surface extension portion 15Ab is, for example, about 2% or more and about 25% or less.

As shown in FIG. 2, in the intervals in the lamination direction T between the first internal electrode layers 15A adjacent to each other in the lamination direction T, the multilayer ceramic capacitor 1 includes a portion in which the interval T1 of the portion which overlaps with the second internal electrode layer 15B in a corresponding one of the connection regions JA where the first counter portion 15Aa and the lateral surface extension portion 15Ab are joined to each other when the first internal electrode layer 15A is seen in a plan view in the lamination direction T is longer than the interval T2 in the central portion of the first counter portions 15Aa, and longer than the interval T3 in the lateral surface extension portion 15Ab which does not overlap with the second internal electrode layers 15B in a plan view in the lamination direction T.

Similarly to the measurement of the existence ratio of the communication holes P into which the dielectric material has entered, the intervals in the lamination direction T of the first internal electrode layers 15A can be measured by polishing the end surface C of the multilayer ceramic capacitor 1 at an angle in parallel or substantially parallel to the end surface C to expose the cross section and observing the cross section using a scanning electron microscope.

Specifically, the interval T1 of the portion which overlaps with the second internal electrode layer 15B in the connection regions JA is measured in a cross-section obtained by polishing the multilayer ceramic capacitor 1 to a position where the dimension of the multilayer ceramic capacitor 1 in the length direction becomes about one half of the dimension of the multilayer ceramic capacitor 1 at an angle perpendicular or substantially perpendicular to the length direction L.

In the above-described cross section, the inner layer portion is divided into three regions so that the thickness dimension thereof is divided into three equal or substantially equal portions, and the dimensions of T1 at 20 locations from each region are measured using a scanning microscope (SEM).

Finally, the average value is calculated as the interval T1 of the portion which overlaps with the second internal electrode layer 15B in the connection region JA.

Similarly to the measurement of T1, the interval T2 in the central portion of the first counter portions 15Aa is divided into three regions so that the thickness dimension of the inner layer portion is equally divided into three, and the dimension of T2 at 20 locations from each region is measured using a scanning microscope (SEM).

Finally, the average value thereof is calculated as the interval T2 in the central portion of the first counter portions 15Aa.

Further, the interval T3 in the lateral surface extension portion 15Ab which does not overlap with the second internal electrode layers 15B when the first internal electrode layer 15A is viewed in a plan view in the lamination direction T is divided into three regions so that the thickness dimension of the inner layer portion is divided into three equal or substantially equal portions in the above-described cross section, and the dimensions of T3 at 20 points from each region are measured using a scanning microscope (SEM).

Finally, an average value thereof is calculated as the interval T3 in the lateral surface extension portions 15Ab which does not overlap with the second internal electrode layer 15B when the first internal electrode layer 15A is seen in a plan view in the lamination direction T.

In addition, in the connection region JA, the interval T1 of the portion which overlaps with the second internal electrode layer 15B is, for example, preferably about 1.2 μm or more and about 6.0 μm or less, the interval T2 at the central portion of the first counter portions 15Aa is, for example, preferably about 1.1 μm or more and about 5.0 μm or less, and the interval T3 at the lateral surface extension portions 15Ab which does not overlap with the second internal electrode layers 15B when the first internal electrode layer 15A is viewed in the lamination direction T is, for example, preferably about 0.8 μm or more and about 5.0 μm or less.

Conventionally, there has been known multi-terminal multilayer ceramic capacitors each including three or more external electrodes as shown in Japanese Unexamined Patent Application, Publication No. 2016-127262. However, in such multi-terminal multilayer ceramic capacitors, the overlapping state of a plurality of internal electrode layers and a plurality of dielectric layers tends to be more complicated than that of a normal two-terminal ceramic capacitor.

For example, the internal electrode layers of the multi-terminal multilayer ceramic capacitor often do not have a simple rectangular or substantially rectangular shape, and the overlapping state between the internal electrode layers and the dielectric layers becomes more complicated.

In this case, at the time of the pressing step before firing the multilayer body, a region to which pressure is hardly applied is generated, and the adhesion force in the vicinity of the region is weakened.

In particular, in the vicinity of the boundary portion between the counter electrode portion and the extension portion, which is likely to become a point of variation in the overlapping state between the internal electrode layers and the dielectric layers, the adhesion force is weakened, and delamination is likely to occur.

According to the present example embodiment, it is possible to provide multilayer ceramic capacitors that are each able to reduce or prevent delamination even in such multi-terminal capacitors.

### Manufacturing Method of Multilayer Ceramic Capacitor 1

Next, an example of a method of manufacturing the multilayer ceramic capacitor 1 will be described.

### First Example Embodiment

In an example of a manufacturing method of the multilayer ceramic capacitor 1, there are a first example embodiment and a second example embodiment depending on the positions where the ceramic pastes 114a and 114b are provided on the first ceramic green sheet 114A and the second ceramic green sheet 114B in the ceramic paste providing step S2 described later.

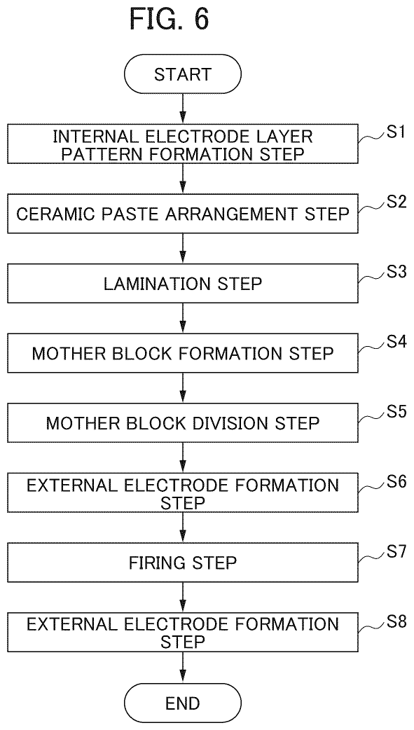

FIG. 6 is a flowchart showing an example of a method of manufacturing the multilayer ceramic capacitor 1.

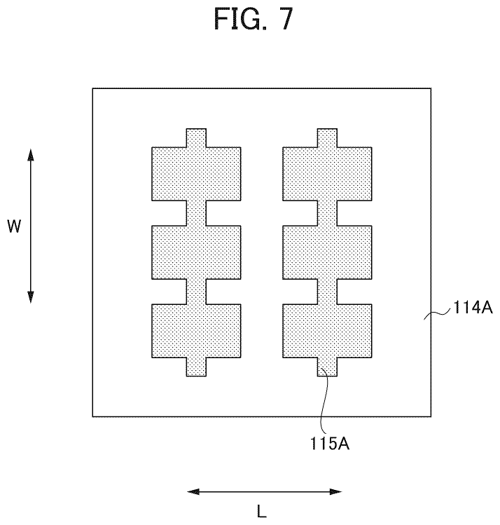

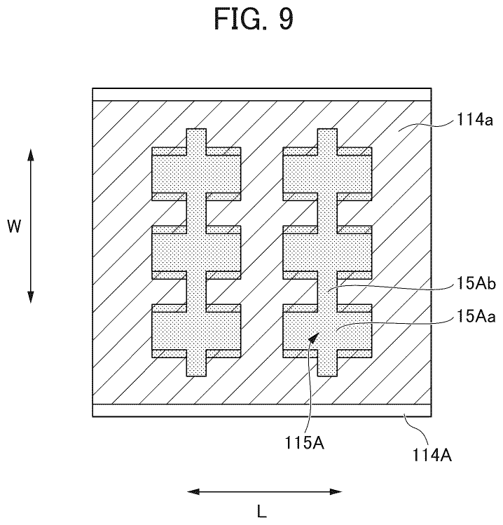

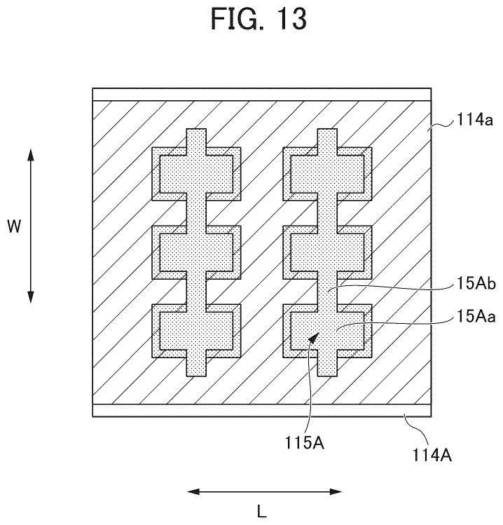

FIGS. 7 to 16 are process charts for showing the method of manufacturing the multilayer ceramic capacitor 1. FIGS. 9 to 12 show the arrangement of the ceramic pastes 114a and 114b according to the first example embodiment. FIGS. 13 to 16 show the arrangement of the ceramic pastes 114a and 114b according to the second example embodiment.

### Internal Electrode Layer Pattern Forming Step S1

First, as shown in FIG. 7, a first internal electrode layer pattern 115A to be the first internal electrode layer 15A is formed on the first ceramic green sheet 114A to be the dielectric layer 14c by an electrically conductive paste.

At this time, the sintering aid is sprayed at a position where the communication holes is to be provided.

With such a configuration, when the ceramic base body is fired, the metal of the internal electrode layers shrinks, and the internal electrode layers becomes discontinuous, such that the communication holes can be formed.

As the sintering aid, for example, Mn, Si, or the like can be used.

The first internal electrode layer pattern 115A has a shape in which the plurality of first internal electrode layers 15A are continuous in the width direction W but discontinuous in the length direction L.

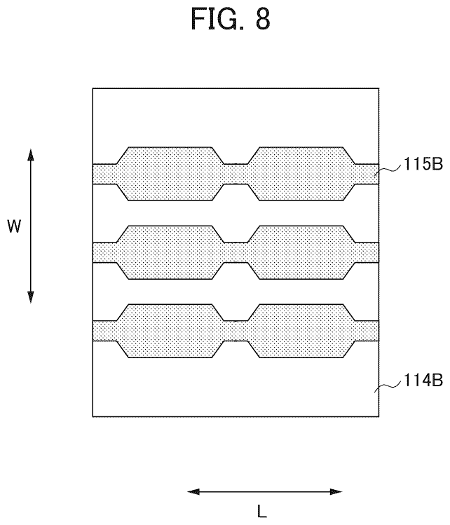

As shown in FIG. 8, a second internal electrode layer pattern 115B to be the second internal electrode layer 15B is formed on the second ceramic green sheet 114B to be the dielectric layer 14c by an electrically conductive paste.

The second internal electrode layer pattern 115B has a shape in which the plurality of second internal electrode layers 15B are continuous in the length direction L but discontinuous in the width direction W.

The ceramic green sheet is a band-shaped sheet in which a ceramic slurry including ceramic powder, a binder, and a solvent is molded into a sheet shape on a carrier film using, for example, a die coater, a gravure coater, a microgravure coater, or the like.

The first internal electrode layer pattern 115A and the second internal electrode layer pattern 115B are formed by, for example, printing such as screen printing, gravure printing, or relief printing.

### Ceramic Paste Arrangement Step S2

Next, as shown in FIG. 9, the ceramic paste 114a for forming the dielectric layer 14b is coated on the sheet in which the first internal electrode layer pattern 115A is formed on the first ceramic green sheet 114A shown in FIG. 7.

The thickness of the dielectric layer 14b is, for example, about 0.4 to about 0.8 times the thickness of the dielectric layer 14c.

In the first example embodiment, the ceramic paste 114a fills the entire or substantially the entire portion of the first ceramic green sheet 114A where the first internal electrode layer pattern 115A is not provided, and is provided so as to overlap portions of both side edges of the first counter portion 15Aa in the width direction W excluding the connection regions JA of the first counter portion.

The ceramic paste 114a is not provided in a portion to be the lateral surface extension portions 15Ab of the first internal electrode layer 15A.

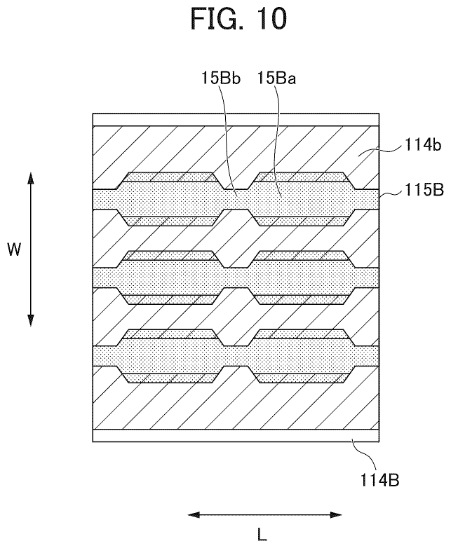

Further, as shown in FIG. 10, the ceramic paste 114b to be the dielectric layer 14a is coated on the sheet in which the second internal electrode layer pattern 115B is formed on the second ceramic green sheet 114B shown in FIG. 8.

The thickness of the dielectric layer 14a is, for example, about 0.4 to about 0.8 times the thickness of the dielectric layer 14c.

In the first example embodiment, the ceramic paste 114b fills the entire or substantially the entire portion of the second ceramic green sheet 114B where the second internal electrode layer pattern 115B is not provided, and is provided so as to overlap portions of the second internal electrode layer pattern 115B corresponding to both side edges of the second counter portion 15Ba in the width direction W.

The ceramic paste 114a and the ceramic paste 114b are applied by printing such as, for example, screen printing, gravure printing, or relief printing.

The ceramic paste may have a different component ratio from the dielectric as the material of the ceramic green sheet, may have the same component ratio, or may include different components.

### Lamination Step S3

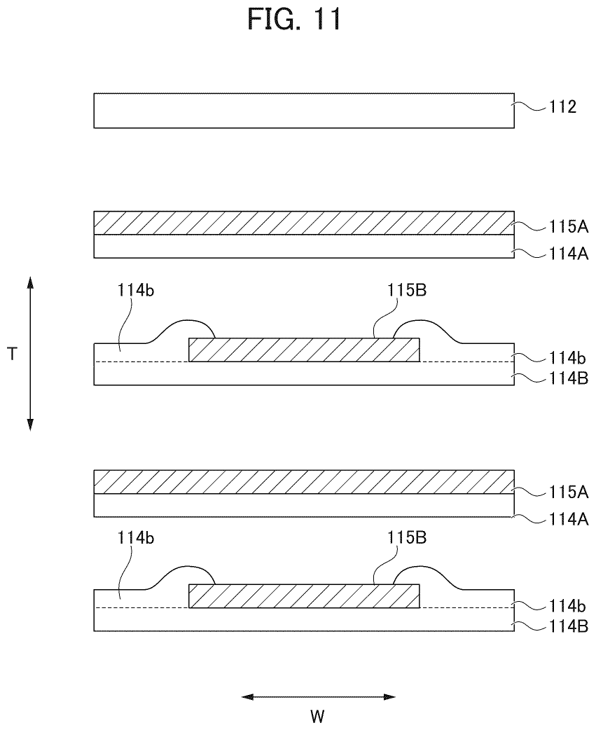

FIG. 11 is a diagram showing the laminated state of the multilayer body 2 in the WT cross section in the middle in the length direction L.

For convenience of description, FIG. 11 schematically shows a state in which a plurality of ceramic green sheets to be laminated are separated from each other.

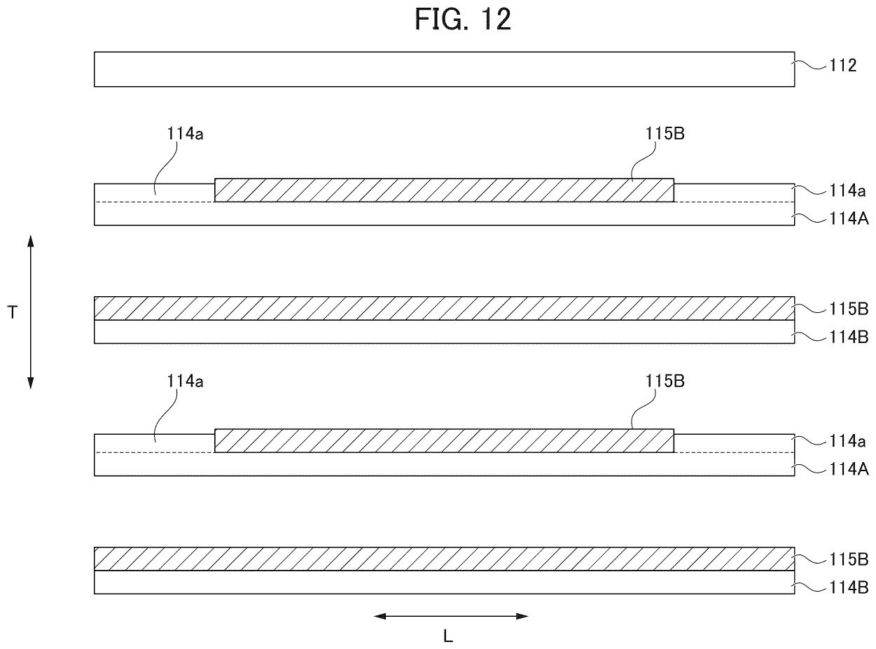

The same applies to FIGS. 12, 15, and 16.

As shown, a sheet in which the first internal electrode layer pattern 115A and the ceramic paste 114a are provided on the first ceramic green sheet 114A shown in FIG. 9 and a sheet in which the second internal electrode layer pattern 115B and the ceramic paste 114b are provided on the second ceramic green sheet 114B shown in FIG. 10 are alternately laminated.

The ceramic paste 114b forms the dielectric layer 14a.

FIG. 12 is a diagram showing the laminated state of the multilayer body 2 in the LT cross section in the middle in the width direction W.

Both of the first internal electrode layer pattern 115A and the second internal electrode layer pattern 115B extend in the length direction L with a constant interval in the lamination direction T. The ceramic paste 114a forms the dielectric layer 14b.

Further, the ceramic green sheets 112 for forming the outer layer portion to be the outer layer portion 12 are laminated on both sides of the multilayer body in the lamination direction T.

### Mother Block Formation Step S4

The ceramic green sheet 112 for forming the outer layer portion and a plurality of laminated sheets are thermocompression-bonded to form a mother block.

### Mother Block Division Step S5

Next, the mother block is cut and divided in the length direction L and the width direction W to manufacture a plurality of rectangular multilayer bodies 2.

### External Electrode Formation Step S6

Next, the end surface external electrodes 3 are formed on both end surfaces C of each of the multilayer bodies 2, and the lateral surface external electrodes 4 are formed on both lateral surfaces B of each of the multilayer bodies 2.

Each of the end surface extension portions 15Bb of the second internal electrode layer 15B is connected to the end surface external electrodes 3.

Each of the end surface external electrodes 3 covers not only the end surface C but also a portion of the main surface A and a portion of the lateral surface B adjacent to the end surface C.

Each of the lateral surface extension portions 15Ab of the first internal electrode layers 15A is connected to the lateral surface external electrodes 4.

Each of the lateral surface external electrodes 4 cover not only a portion of the lateral surface B but also a portion of the main surface A adjacent to the lateral surface B.

### Firing Step S7

Then, heating is performed for a predetermined period of time in a nitrogen atmosphere, for example, at the set firing temperature.

As a result, the external electrodes are fired on the multilayer body 2, and the multilayer ceramic capacitor 1 shown in FIG. 1 is manufactured.

In the firing step, the multilayer chip is subjected to a binder removal treatment and a firing treatment to form a base body portion (the multilayer body 2).

The electrically conductive paste layer and the dielectric layer green sheet are co-sintered by firing to form the internal electrode layer 15 and the dielectric layer 14, respectively.

The condition of the binder removal treatment may be determined according to the type of the organic binder included in the green sheet and the electrically conductive paste layer.

The firing treatment may be performed at a temperature at which the multilayer chip is sufficiently densified.

The firing temperature is, for example, preferably about 900° C. to about 1400° C., although it depends on the materials of the dielectric and the internal electrode layers.

As shown in FIG. 2, the multilayer ceramic capacitor 1 manufactured in this manner includes a portion in which, in the intervals in the lamination direction T between the first internal electrode layers 15A adjacent to each other in the lamination direction T, the multilayer ceramic capacitor 1 includes a portion in which the interval T1 of the portion of the first counter portion 15Aa which overlaps with the second internal electrode layer 15B in a corresponding one of the connection regions JA to which the lateral surface extension portion 15Ab is joined when the first internal electrode layers 15A are seen in a plan view in the lamination direction T is longer than the interval T2 of the central portion of the first counter portion 15Aa, and longer than the interval T3 of the lateral surface extension portions 15Ab which do not overlap with the second internal electrode layer 15B in a plan view in the lamination direction T.

As described above, since the interval T1 is larger than the intervals T2 and T3 in the portion of the first counter portion 15Aa which overlaps with the second internal electrode layer 15B in the connection region JA to which the lateral surface extension portion 15Ab is joined, the pressure from the dielectric layer 14 is likely to be applied to this portion.

Therefore, in this portion, since a portion of the dielectric forming the dielectric layer 14 easily enters the communication holes P of the internal electrode layers 15, columnar crystals are easily formed by the dielectric, and it is possible to increase the adhesion force between the internal electrode layers 15 and the dielectric layers 14.

For this reason, the existence ratio of the communication holes P into which the dielectric has entered in the first internal electrode layers is higher at the connection region JA of the first counter portion 15Aa to which the lateral surface extension portion 15Ab is connected than the central portion of the first counter portion 15Aa and higher than the central portion of the lateral surface extension portion 15Ab, such that it is possible to increase the adhesion force with the dielectric layer 14 in the connection region JA.

In the multilayer body 2, as shown in FIG. 3, both of the first internal electrode layers 15A and the second internal electrode layers 15B extend in the length direction L with a constant interval in the lamination direction T.

### External Electrode Formation Step S8

A plated layer is provided as necessary.

In the present example embodiment, for example, the Ni plated layer and the Sn plated layer are formed on the fired layer.

The Ni plated layer and the Sn plated layer are sequentially formed by barrel plating, for example. Thus, the multilayer ceramic capacitor 1 can be obtained.

### Second Example Embodiment

Next, a second example embodiment of the present invention will be described.

The second example embodiment is different from the first example embodiment in the range of the ceramic pastes 114a and 114b provided on the ceramic green sheet on which the internal electrode layer pattern is formed.

FIG. 13 is a view showing a state in which the ceramic paste 114a is provided on the sheet in which the first internal electrode layer pattern 115A is formed on the first ceramic green sheet 114A in the second example embodiment, and corresponds to FIG. 9 of the first example embodiment.

As shown in FIG. 13, the ceramic paste 114a fills the entire or substantially the entire portion of the first ceramic green sheet 114A where the first internal electrode layer pattern 115A is not provided, and is provided so as to overlap both side edges of the first counter portion 15Aa in the length direction L and both side edges of the first counter portion 15Aa in the width direction W excluding the connection regions JA of the first counter portion.

Although FIG. 13 shows a configuration in which the ceramic paste 114a is not provided at the portion to be the lateral surface extension portion 15Ab of the first internal electrode layer 15A, the present invention is not limited to this, and the ceramic paste 114a may also be provided at the portion to be the lateral surface extension portion 15Ab of the first internal electrode layer 15A and the connection region JA where the first counter portion 15Aa and the lateral surface extension portion 15Ab are joined.

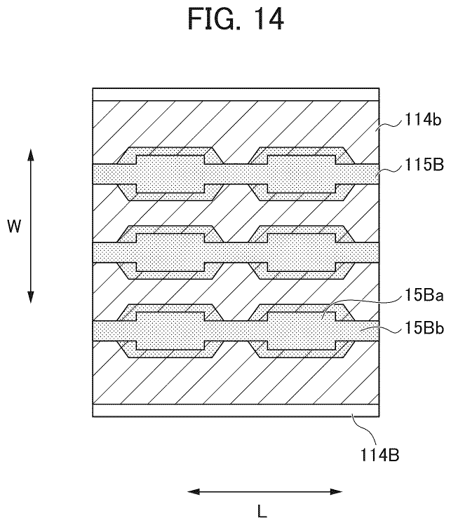

FIG. 14 is a view showing a state in which the ceramic paste 114b is provided on the sheet in which the second internal electrode layer pattern 115B is formed on the second ceramic green sheet 114B in the second example embodiment, and corresponds to FIG. 10 of the first example embodiment.

As shown in FIG. 14, the ceramic paste 114b fills the entire or substantially the entire portion of the second ceramic green sheet 114B where the second internal electrode layer pattern 115B is not provided, and is provided so as to overlap a portion of the second internal electrode layer pattern 115B corresponding to both side edges of the second counter portion 15Ba in the width direction W and portions of the second counter portion 15Ba at both ends in the length direction L and corresponding to four positions corresponding to both ends in the width direction W.

The ceramic paste 114b is not provided in a portion to be the end surface extension portion 15Bb of the second internal electrode layer 15B.

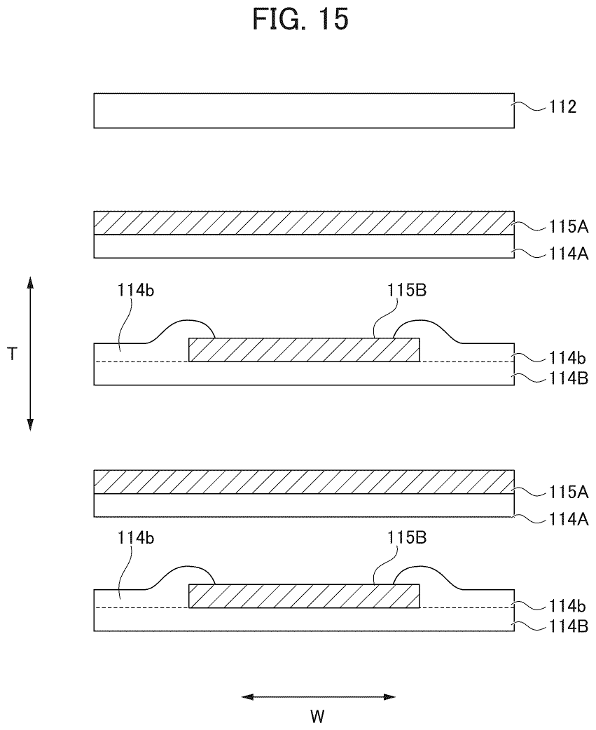

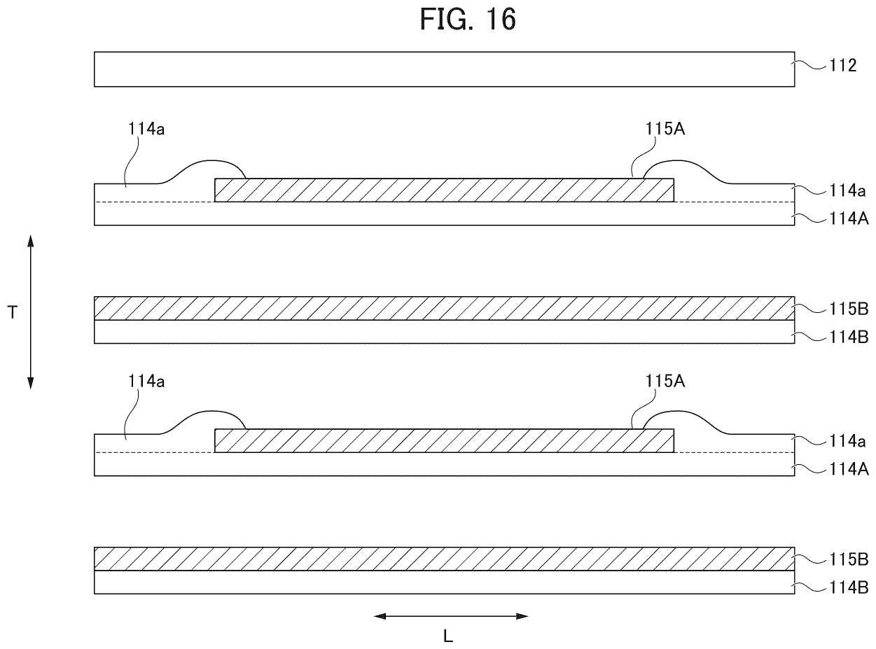

FIGS. 15 and 16 show a state in which the sheet in which the first internal electrode layer pattern 115A and the ceramic paste 114a are provided on the first ceramic green sheet 114A shown in FIG. 13, and the sheet in which the second internal electrode layer pattern 115B and the ceramic paste 114b to be the dielectric layer 14a are provided on the second ceramic green sheet 114B shown in FIG. 14 are alternately laminated.

As shown in FIG. 15, the ceramic paste 114b overlaps both ends of the second internal electrode layer pattern 115B in the width direction W.

The ceramic paste 114b forms the dielectric layer 14a.

As shown in FIG. 16, the ceramic paste 114a overlaps both ends of the first internal electrode layer pattern 115A in the length direction L.

The ceramic paste 114a forms the dielectric layer 14b.

Such a configuration corresponds to FIG. 11 of the first example embodiment, and a cross section corresponding to FIG. 2 of the first example embodiment is formed.

For this reason, in the second example embodiment, the existence ratio of the communication holes P into which the dielectric has entered in the second internal electrode layer 15B is higher at a corresponding one of the connection regions JB to which the end surface extension portion 15Bb of the second counter portion 15Ba is connected than the central portion of the second counter portion 15Ba and higher than the central portion of the end surface extension portion 15Bb, such that it is possible to improve the adhesion force with the dielectric layer 14.

Since the cross section shown in FIG. 15 also corresponds to FIG. 11 of the first example embodiment and the cross section corresponding to FIG. 2 of the first example embodiment, it is possible to improve the adhesion force with the dielectric layer 14 also in the connection region JA where the first counter portion 15Aa and the lateral surface extension portion 15Ab are joined.

As described above, the same or substantially the same advantageous effects as those of the first example embodiment can also be obtained in the second example embodiment.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including an inner layer portion including plurality of dielectric layers and a plurality of internal electrode layers are laminated, two main surfaces opposed to each other in a lamination direction, two end surfaces opposed to each other in a length direction intersecting the lamination direction, and two lateral surfaces opposed to each other in a width direction intersecting the lamination direction and the length direction; and
an external electrode connected to the plurality of internal electrode layers on at least one of the two lateral surfaces or the two end surfaces of the multilayer body; wherein
the plurality of internal electrode layers include first internal electrode layers and second internal electrode layers;
the first internal electrode layers and the second internal electrode layers each include a counter portion overlapping each other in a plan view in the lamination direction, and an extension portion extending from the counter portion toward one of the two end surfaces or one of the lateral surfaces of the multilayer body and not overlapping each other in a plan view in the lamination direction;
the plurality of internal electrode layers each include a communication hole communicating in the lamination direction and into which a dielectric of the plurality of dielectric layers has entered; and
an existence ratio of the communication hole into which the dielectric has entered is higher at a connection region of the counter portion to which the extension portion is connected than at a central portion of the counter portion and higher than a central portion of the extension portion.

2. The multilayer ceramic capacitor according to claim 1, wherein
the first internal electrode layers each include a first counter portion opposed to a corresponding one of the second internal electrode layers via a corresponding one of the plurality of dielectric layers, and a lateral surface extension portion extending from the first counter portion toward a corresponding one of the lateral surfaces of the multilayer body;
the second internal electrode layers each include a second counter portion opposed to a corresponding one of the first internal electrode layers via a corresponding one of the plurality of dielectric layers, and an end surface extension portion extending from the second counter portion toward a corresponding one of the two end surfaces of the multilayer body;
a length of the multilayer ceramic capacitor in the length direction is longer than a width of the multilayer ceramic capacitor in the width direction; and
an existence ratio of the communication hole in each of the first internal electrode layers is higher at a connection region of the first counter portion to which the lateral surface extension portion is connected than a central portion of the first counter portion and higher than a central portion of the lateral surface extension portion.

3. The multilayer ceramic capacitor according to claim 2, wherein
the multilayer ceramic capacitor includes a portion in which, in an interval in the lamination direction of the first internal electrode layers adjacent to each other in the lamination direction, an interval T1 in the connection region overlapping with the second internal electrode layers when the first internal electrode layers are seen in a plan view in the lamination direction is longer than an interval T2 in a central portion of the first counter portion.

4. The multilayer ceramic capacitor according to claim 2, wherein
in the first internal electrode layers each including two lateral surface extension portions extending toward the two lateral surfaces of the multilayer body opposed to each other in the width direction, an existence ratio of the communication hole into which the dielectric has entered is higher at two connection regions of the first counter portion to which the two lateral surface extension portions are respectively connected than a central portion of the first counter portion and higher than a central portion of the two lateral surface extension portion.

5. The multilayer ceramic capacitor according to claim 2, wherein, in each of the first internal electrode layers, a dimension of the lateral surface extension portion in the length direction is shorter than a dimension of the first counter portion in the length direction.

6. The multilayer ceramic capacitor according to claim 4, wherein, in each of the first internal electrode layers, dimensions in the length direction of the two lateral surface extension portions extending toward the two lateral surfaces of the multilayer body opposed to each other in the width direction are both shorter than a dimension of the first counter portion in the length direction.

7. The multilayer ceramic capacitor according to claim 2, wherein, in each of the second internal electrode layers, a dimension of the end surface extension portion in the width direction is shorter than a dimension of the first counter portion in the width direction.

8. The multilayer ceramic capacitor according to claim 4, wherein, in each of the second internal electrode layers, lengths in the width direction of two end surface extension portions are both shorter than a dimension of the first counter portion in the width direction.

9. The multilayer ceramic capacitor according to claim 1, wherein
the first internal electrode layers each include a first counter portion opposed to a corresponding one of the second internal electrode layers via a corresponding one of the plurality of dielectric layers, and a lateral surface extension portion that extends from the first counter portion toward a corresponding one of the lateral surfaces of the multilayer body;
the second internal electrode layers each include a second counter portion opposed to a corresponding one of the plurality of first internal electrode layers via a corresponding one of the plurality of dielectric layers, and an end surface extension portion extending from the second counter portion toward a corresponding one of the two end surfaces of the multilayer body;
the plurality of internal electrode layers each include a communication hole communicating in the lamination direction and into which a dielectric of the plurality of dielectric layers has entered;
a length of the multilayer ceramic capacitor in the length direction is longer than a width of the multilayer ceramic capacitor in the width direction; and
an existence ratio of the communication hole in each of the second internal electrode layers is higher at a connection region of the second counter portion to which the end surface extension portion is connected than a central portion of the second counter portion and higher than a central portion of the end surface extension portion.

10. The multilayer ceramic capacitor according to claim 3, wherein a length of the multilayer ceramic capacitor in the length direction is longer than a width of the multilayer ceramic capacitor in the width direction.

11. The multilayer ceramic capacitor according to claim 3, wherein T1 is about 1.2 μm or more and about 6.0 μm or less.

12. The multilayer ceramic capacitor according to claim 3, wherein T2 is about 1.1 μm or more and about 5.0 μm or less.

13. The multilayer ceramic capacitor according to claim 11, wherein T2 is about 1.1 μm or more and about 5.0 μm or less.

14. The multilayer ceramic capacitor according to claim 10, wherein an interval T3 at the lateral surface extension portion which does not overlap with the second internal electrode layers when the first internal electrode layer is viewed in the lamination direction is about 0.8 μm or more and about 5.0 μm or less.

15. The multilayer ceramic capacitor according to claim 13, wherein an interval T3 at the lateral surface extension portion which does not overlap with the second internal electrode layers when the first internal electrode layer is viewed in the lamination direction is about 0.8 μm or more and about 5.0 μm or less.

16. The multilayer ceramic capacitor according to claim 2, wherein an existence ratio of the communication hole at the connection region of the first counter portion to which the lateral surface extension portion is connected is about 20% or more and about 60% or less.

17. The multilayer ceramic capacitor according to claim 2, wherein an existence ratio of the communication hole at the central portion of the first counter portion is about 2% or more and about 25% or less.

18. The multilayer ceramic capacitor according to claim 2, wherein an existence ratio of the communication hole at the central portion of the lateral surface extension portion is about 2% or more and about 25% or less.

19. The multilayer ceramic capacitor according to claim 16, wherein an existence ratio of the communication hole at the central portion of the first counter portion is about 2% or more and about 25% or less.
